(19) United States
(12) Patent Application Publication
(10) Pub. No.: US 2008/0130765 A1
(43) Pub. Date: Jun. 5, 2008

(54) Method and Apparatus for Multiple Input Multiple Output Wireless

(76) Inventor: Jim Wight, Ottawa (CA)

Correspondence Address: Anderson Gorecki & Manaras LLP, 33 NAGOG PARK, ACTON, MA, 01720, US

(21) Appl. No.: 11/566,745

(22) Filed: Dec. 5, 2006

(51) Int. Cl. H04L 27/28

(52) U.S. Cl. 375/260

(57) ABSTRACT

A method and system for communicating multiple input multiple output (MIMO) wireless data comprising inputs for a plurality of signals Si, a network for weighting each of a plurality of signals Si for each of a plurality of transmit antennas and combining signals weighted for each of the plurality of antennas, a plurality of antennas for transmitting the plurality of combined signals, a plurality of antennas for receiving a plurality of signals on a plurality of receive antennas, a receiver for recovering a second plurality of signals So by deriving receiver weightings for each of the plurality of received signals in dependence upon the respective transmitter weightings by factoring a matrix H representative of a channel between the plurality of transmit and receive antennas. The receiver includes means for factoring the channel matrix H into two matrices, the second of which is a first unitary matrix, means for decomposing the first unitary matrix to provide an upper triangular matrix whose principal diagonal comprises eigenvalues of the first unitary matrix and a second unitary matrix and means for factoring in parallel rows of the upper triangular matrix to isolate eigenvalues λⱼ ans Soⱼ=λⱼSiⱼ. Factoring the channel matrix H includes a LQ decomposition: H=LQ₁ where L is a lower triangular matrix and Q₁ is a Unitary matrix. Decomposing the first unitary matrix Q₁ includes a Schur decomposition Q₁=Q₂*UQ₂⁻¹ where U is an upper triangular matrix with the principal diagonal being the eigenvalues of Q₁ and Q₂ is the second Unitary Matrix. Factoring in parallel includes factoring U as U=MⱼTⱼ where Tⱼ is a matrix formed by transposing the elements to the right of the principal diagonal of the j^{th} row of the upper triangular matrix, into the elements below the principal diagonal of the j^{th} column, while leaving all other rows untouched.

### FIELD OF THE INVENTION

The present invention relates to methods and apparatuses for multiple input multiple output (MIMO) wireless.

### BACKGROUND OF THE INVENTION

Multiple-Input-Multiple-Output (MIMO) refers to a technique in which two or more independent signals are transmitted simultaneously over the same bandwidth at the same time, and are received without any mutual interference. This technique is not based on the use of excess bandwidth, as is direct sequence spread spectrum, but instead constructively employs the presence of multi-path propagation to form “parallel channels” between the transmitter and the receiver. In environments where no multi-path propagation exists, such as between two satellites in orbit, MIMO operation is not possible.

The “parallel channels” needed for MIMO to function are created by having more than one physical antenna at the transmitter and more than one physical antenna at the receiver. The two or more independent signals at the transmitter are “blended” together before being radiated by the transmitter antennas, each antenna radiating a different “blended” composite signal. At the receiver, each antenna receives a different composite signal, resulting from the effects of the individual channels connecting each transmitter antenna to each receiver antenna, and “un-blends” then to produce replicas of the original independent signals at the transmitter.

Any wireless link having multiple antennas located at both the transmitting end and at the receiving end can be represented by a transmission matrix, H, the elements of which represent the individual transfer functions between all pairs of transmit and receive antennas.

In order to fully make use of the channel capacity that such a link offers, it is necessary to provide complex weights at both the transmitter and receiver, such that the resulting cascaded matrix becomes diagonal. Multiple, independent signals can then be transmitted simultaneously from the transmitter to the receiver.

As an example, a 2×2 MIMO system including a transmitter 10 having two transmitter antennas and a receiver 12 having two receiver antennas, plus the associated processing weights, Wjk and Vjk for MIMO operation is shown in FIG. 1.

Let the multiple input signals be represented by the vector Si and the multiple output signals be represented by the vector So. Then:

So=V^{T}HWSi

where: V^{T} represents the complex weights at the receiver
W represents the complex weights at the transmitter

If V^{T} and W are chosen correctly, then:

V^{T}HW=Λ
where A is a diagonal matrix.

As a result, the multiple output signals become representations of the multiple input signals each multiplied by a different value of the principal diagonal of the matrix Λ.

So=ΛSi

Two well known decomposition techniques are the eigenvalue decomposition and the singular value decomposition. In order to understand the strengths and weaknesses for these decomposition techniques, as well as for the present invention described here, it is first necessary to review some matrix theory.

For any matrix H, eigenvectors, xⱼ exist that satisfy the relationship:

Hxⱼ=λxⱼ

where λ is a complex constant called an eigenvalue.

The multiple eigenvector solutions to the above equation can be grouped together as column vectors, in a matrix X. This allows the multiple eigenvector equations to be written as a matrix equation.

HX=XΛ

where the individual eigenvalues form the diagonal elements of the diagonal matrix Λ.

Λ Unitary matrix is one whose transposed element values are equal to the complex conjugate of the elements of its inverse:

H^{T}=H⁻¹*

A result of the above property is that the individual column (or row) vectors hⱼ that make

up a unitary matrix are mutually perpendicular (orthogonal for a matrix of real values).

hⱼ*^{T}hₖ=δⱼ−1,j=k0,j≠k

The eigenvalues of a Unitary matrix all lay on the unit circle of the complex plane, as shown in FIG. 2.

A Hermitian matrix is one whose transposed element values are equal to the complex conjugate of its elements:

H^{T}=H*

### Hence:

H=H*^{T}=H^{H}

where ^{H} denotes the conjugate transpose.

A property of a Hermitian matrix is that the matrix composed of its Eigenvectors is Unitary. The Eigenvalues of a Hermitian matrix all lay on the positive real axis of the complex plane, as shown in FIG. 2.

Eigenvalue Decomposition (EVD) is a known method of matrix decomposition. The Eigenvalues of a channel matrix provide a method for diagonalization, and hence for an increase in channel capacity with MIMO.

Allow statistically independent signals, Si to be applied to the transmitter antennas through transmitter weights Wⱼₖ and associated power combiners. This is shown in FIG. 1 for the 2×2 case. At the transmitter, the Eigenvalue decomposition weights, Wⱼₖ form column vectors, Wⱼ that help to establish the individual traffic channels.

The multiple eigenvector equations can be written as the matrix equation:

HX=XΛ

Here: H represents the link transmission matrix
Λ represents a diagonal matrix, the elements of which are the individual eigenvalues.

Post-multiplying both sides of the above equation by X⁻¹ yields:

H=XΛX⁻¹

Operation of an Eigenvalue Decomposition MIMO is now described. Considering the above diagonalization of the channel matrix, it can be seen that if the transmitter weights W are chosen to be equal to X, and if the receiver weights V^{T} are chosen to be the inverse of X, then:

$$\begin{matrix}So = {V}^{T} HWSi \\ = {X}^{- 1} HXSi \\ = {X}^{- 1} X Λ {X}^{- 1} XSi \\ = Λ Si\end{matrix}$$

One difficulty with Eigenvalue Decomposition is that the eigenvectors are not mutually perpendicular since the weighting matrices formed from the eigenvectors are not Unitary. This can result in significant cross-talk between the multiple signals on the link. In addition, this will result in the transmitter power amplifiers being driven at different power levels, with one being over driven (thereby increasing its bit error rate and decreasing its throughput rate) and another being under driven (thereby decreasing its range of coverage).

A second difficulty with Eigenvalue Decomposition is that the eigenvalues may vary greatly in magnitude. Large variations in magnitude result in large differences in the received signal-to-noise ratios for the received, “de-blended” signals. Signals having poor signal-to-noise ratio will either have less range for a specified bit error rate, or a high bit error rate for a specified range, compared to a signal having a strong signal-to-noise ratio.

Singular Value Decomposition (SVD) is another know method of matrix decomposition.

Again, allow two statistically independent signals, Si to be applied to the transmitter antennas through transmitter weights Wᵢⱼ, and associated power combiners. This is again shown in FIG. 1 for the 2×2 case.

Here, the SVD weights, Wⱼₖ form column vectors, Wⱼ that help to establish the individual traffic channels. Similarly, the signals arriving from the receive antennas, So pass through the SVD weights, Vⱼₖ*, where * represents a complex conjugate operation. Again, these weights form column vectors, Vⱼ* that help to establish the individual traffic channels.

The transmission matrix, H representing individual paths from the various transmitter antennas to the various receiver antennas, consists of elements Hⱼₖ.

For any matrix, H, the Gramm matrix H^{H}H and the outer product matrix HH^{H} are both Hermitian. Here ^{H} denotes the conjugate transpose.

Further, the Eigenvalues, λj have the same values for both H^{H}H and HH^{H}.

### Hence:

(H^{H}H)W=WΛ

and:

(HH^{H})V=VΛ

where
Λ is the diagonal matrix of λj
V is the unitary matrix [V₁ V₂ Vₙ] of eigenvectors of OP=H^{H}H
W is the unitary matrix [W₁ W₂ Wₙ] of eigenvectors of G=H^{H}H

In order to satisfy both of the above Eigenvector equalities (for the outer product matrix and for the Gramm matrix), H, the channel transfer matrix can be written as:

H=VΛ^{1/2}W^{H}

Here, the input signals, Si pass through the transmitter SVD weights, Wⱼₖ and are radiated through the transmission matrix, H to the receive antennas. Mathematically, this can be represented by H W. Upon reception, the signals pass through the receiver SVD weights, Vⱼₖ* to form the output signals, So. Using the above equation, this can be represented by:

$$\begin{matrix}So = {V}^{H} HWSi \\ = {V}^{H} V {Λ}^{1 / 2} {W}^{H} WSi \\ = {Λ}^{1 / 2} Si\end{matrix}$$

One advantage of Singular Value Decomposition is that the eigenvectors are all mutually perpendicular, since the weighting matrices formed from the eigenvectors are Unitary. This can result in a significant suppression of cross-talk between the multiple signals on the link. It also ensures that the parallel power amplifiers are driven at equal power levels, thereby ensuring that each power amplifier will deliver an equal bit error rate and an equal range.

A difficulty with the Singular Value Decomposition is that the eigenvalues may vary greatly, in magnitude. Large variations in magnitude result in better signal-to-noise ratios for some of the received signals at the expense of the signal-to-noise ratios for some of the other received signals.

Methods and apparatuses for multiple input multiple output (MIMO) wireless are disclosed to obviate or mitigate at least some of the aforementioned disadvantages.

### SUMMARY OF THE INVENTION

An object of the present invention is to provide improved methods and apparatuses for multiple input multiple output (MIMO) wireless.

In accordance with an aspect of the present invention there is provided a system for communicating multiple input multiple output (MIMO) wireless data comprising inputs for a plurality of signals Si, a network for weighting each of a plurality of signals Si for each of a plurality of transmit antennas and combining signals weighted for each of the plurality of antennas, a plurality of antennas for transmitting the plurality of combined signals, a plurality of antennas for receiving a plurality of signals on a plurality of receive antennas, and a receiver for recovering a second plurality of signals So by deriving receiver weightings for each of the plurality of received signals in dependence upon the respective transmitter weightings by factoring a matrix H representative of a channel between the plurality of transmit and receive antennas.

In accordance with another aspect of the present invention there is provided a method of communicating multiple input multiple output (MIMO) wireless data comprising the steps of weighting each of a plurality of signals Si for each of a plurality of transmit antennas, combining signals weighted for each of the plurality of antennas, transmitting the plurality of combined signals, receiving a plurality of signals on a plurality of receive antennas, and recovering a second plurality of signals So by deriving receiver weightings for each of the plurality of received signals in dependence upon the respective transmitter weightings by factoring a matrix H representative of a channel between the plurality of transmit and receive antennas.

### BRIEF DESCRIPTION OF THE DRAWINGS

The present invention will be further understood from the following detailed description with reference to the drawings in which:

FIG. 1 illustrates environments in which multiple input multiple output (MIMO) system have difficulty operating effectively; and

FIG. 2 illustrates typical wireless communications equipment components; and

FIG. 3 illustrates determining output signals for a MIMO system in accordance with an embodiment of the present invention.

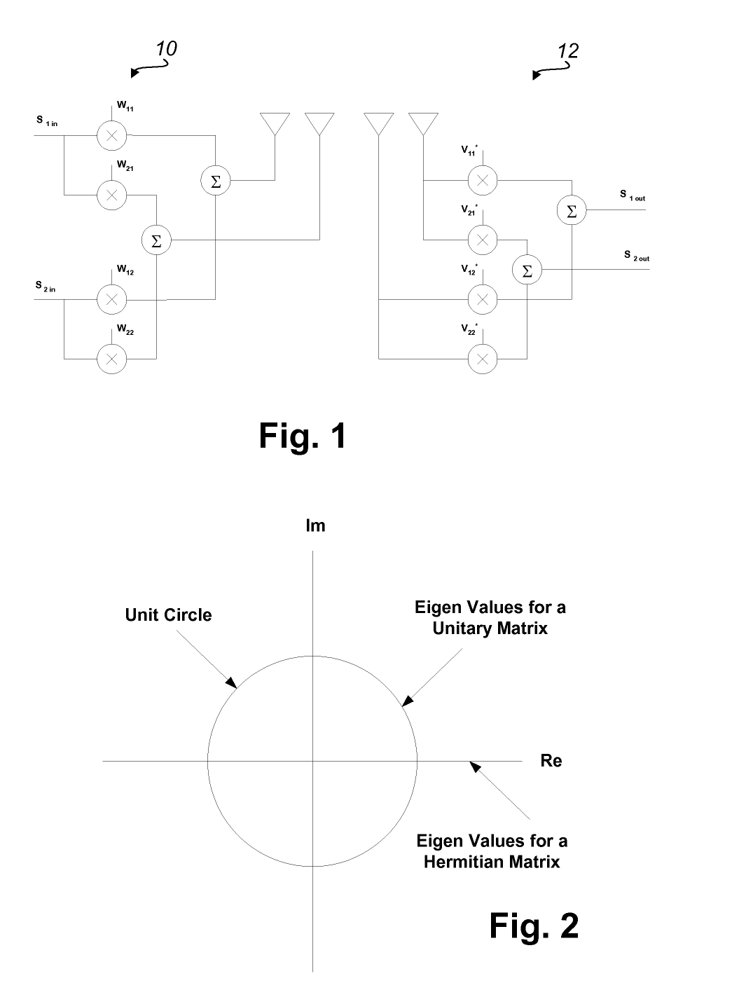

### DETAILED DESCRIPTION OF THE PREFERRED EMBODIMENT

In accordance with an embodiment of the present invention there is provided a technique, referred to herein after as Concatenated Decomposition that ensures equal magnitude eigenvalues in the decomposition, thereby ensuring equal signal-to-noise ratios for the received signals. The transmitter weighting coefficients form a Unitary matrix, which ensures equal drive level for all transmitter power amplifiers, and minimizes cross-talk between the multiple signals on the link. The receiver weighting coefficients do not form a Unitary matrix. However, since the receiver signal levels are low and most of the receiver de-blending operation is performed digitally after the analog-to-digital conversions, this has no real effect on performance. The Concatenated Decomposition technique is based on three complementary concepts.

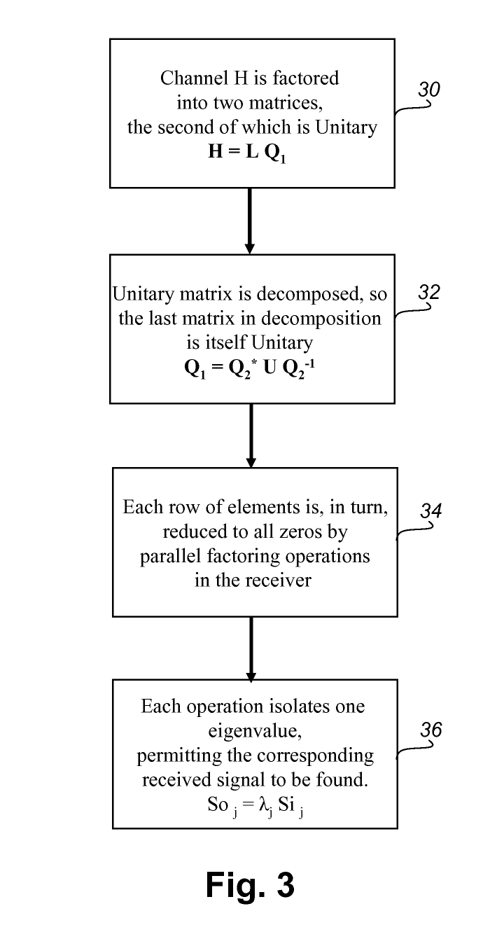

Referring to FIG. 3 there is illustrated a method of determining output signals for a MIMO system in accordance with an embodiment of the present invention. First, the channel H is factored 30 into two matrices, the second of which is Unitary. One way of achieving this is to use the LQ decomposition.

H=LQ₁

where: L is a lower triangular matrix
Q₁ is a Unitary matrix

Second, the Unitary matrix is decomposed 32, such that the last matrix in the decomposition is itself Unitary. One way of achieving this is to use the Schur decomposition.

Q₁=Q₂*UQ₂⁻¹
where: U is an upper triangular matrix with the principal diagonal being the eigenvalues of Q₁
   Q₂ is another Unitary Matrix

The last matrix (on the right) is Unitary. Using the matrix Q₂ as the transmission coefficients ensures the transmitter power amplifiers are equally driven in signal level, and ensures the cross-talk between the individual signals in the transmitter is minimized. Also, since the elements along the principal diagonal of U are the eigenvalues of Q₁, they lie on the unit circle of the complex plane. As such, the received signals have equal signal-to-noise ratios, thus equalizing each signals bit error rate at equal distances.

Third, excluding the principal diagonal elements of the upper triangular matrix, each row of elements is, in turn, reduced to all zeros by using parallel factoring operations 34 in the receiver. Each of these operations isolates one eigenvalue, permitting the corresponding received signal to be found 36.

Soⱼ=λⱼSiⱼ

One way of achieving this is to use the following factoring operation.

U=MⱼTⱼ
where: Tⱼ is a matrix formed by transposing the elements to the right of the principal diagonal of the j^{th} row of the upper triangular matrix, into the elements below the principal diagonal of the j^{th} column, while leaving all other rows untouched

Mⱼ is the matrix which provides this “single row partial transpose operation”.

For example, for a 2×2 matrix, the upper triangular matrix U is:

$$U = [ \begin{matrix}λ 1 & a \\ 0 & λ 2\end{matrix} ]$$

The only “single row partial transpose operation” is for the top row, giving:

$$T 1 = [ \begin{matrix}λ 1 & 0 \\ a & λ 2\end{matrix} ]$$

The M1 matrix which provides this “single row partial transpose operation” is:

$$M 1 = [ \begin{matrix}1 - \frac{{a}^{2}}{λ 1 λ 2} & \frac{a}{λ 2} \\ \frac{- a}{λ 1} & 1\end{matrix} ]$$

Similarly, for a 3×3 matrix, the upper triangular matrix U is:

$$U = [ \begin{matrix}λ 1 & b & a \\ 0 & λ 2 & c \\ 0 & 0 & λ 3\end{matrix} ]$$

Two “single row partial transpose operations” are now needed to isolate λ₁ and λ2. The first yields:

$$T 1 = [ \begin{matrix}λ 1 & 0 & 0 \\ b & λ 2 & c \\ a & 0 & λ 3\end{matrix} ]$$

and the corresponding M1 matrix which provides this “single row partial transpose operation” is:

$$M 1 = [ \begin{matrix}1 - \frac{{a}^{2}}{λ 1 λ 3} - \frac{{b}^{2}}{λ 1 λ 2} + \frac{abc}{λ 1 λ 2 λ 3} & \frac{b}{λ 2} & \frac{a}{λ 3} - \frac{bc}{λ 2 λ 3} \\ - \frac{b}{λ 1} & 1 & 0 \\ - \frac{a}{λ 1} & 0 & 1\end{matrix} ]$$

The second “single row partial transpose operation” yields:

$$T 2 = [ \begin{matrix}λ 1 & b & a \\ 0 & λ 2 & 0 \\ 0 & c & λ 3\end{matrix} ]$$

and the corresponding M2 matrix which provides this “single row partial transpose operation” is:

$$M 2 = [ \begin{matrix}1 & 0 & 0 \\ 0 & 1 - \frac{{c}^{2}}{λ 2 λ 3} & \frac{c}{λ 3} \\ 0 & - \frac{c}{λ 2} & 1\end{matrix} ]$$

A 2×2 Concatenated Decomposition MIMO Technique is now described by way of example. For the 2×2 MIMO case, the output signals are related to the input signals by the channel transfer function and the transmitter and receiver weighting coefficients:

So=VHWSi

The first step results in the channel matrix being factored:

H=LQ₁

This gives the output signals as:

So=VLQ₁WSi

The second step performs Schur decomposition on Q1:

H=LQ₂*UQ₂⁻¹

This allows the output signals to be expressed as:

So=VL Q₂*UQ₂⁻¹WSi

If the transmitter coefficients are chosen as:

W=Q₂

Then the output signals are:

So=VLQ₂*USi

For the second receiver signal, the receiver coefficients are chosen as:

V=[LQ₂*]⁻¹

This gives the output signals as:

So=USi

and the second output signal as:

So₂=λ₂Si₁

To find the first receiver signal, the “single row partial transpose transposition” (the third step) must be performed on U. Here we will have the received signal vector as

So=VLQ₂*M₁T₁Si

A second set of receiver coefficients are chosen as:

V=[LQ₂*M₁]⁻¹

This gives the output signals as:

So=λ₁Si₁

and the first output signal as:

So₁=λ₁Si₁

Numerous modifications, variations and adaptations may be made to the particular embodiments described above without departing from the scope patent disclosure, which is defined in the claims.

What is claimed is:

1. A method of communicating multiple input multiple output (MIMO) wireless data comprising the steps of:
weighting each of a plurality of signals Si for each of a plurality of transmit antennas;
combining signals weighted for each of the plurality of antennas;
transmitting the plurality of combined signals;
receiving a plurality of signals on a plurality of receive antennas; and
recovering a second plurality of signals So by deriving receiver weightings for each of the plurality of received signals in dependence upon the respective transmitter weightings by factoring a matrix H representative of a channel between the plurality of transmit and receive antennas.

2. A method as claimed in claim 1 wherein the step of recovering includes the steps of:
factoring the channel matrix H into two matrices, the second of which is a first unitary matrix;
decomposing the first unitary matrix to provide an upper triangular matrix whose principal diagonal comprises eigenvalues of the first unitary matrix and a second unitary matrix; and
factoring in parallel rows of the upper triangular matrix to isolate eigenvalues λⱼ and Soⱼ=λⱼSiⱼ.

3. A method as claimed in claim 2 wherein the step of factoring the channel matrix H includes using LQ decomposition:
H=LQ₁
where: L is a lower triangular matrix
Q₁ is a Unitary matrix.

4. A method as claimed in claim 3 wherein the step of decomposing the first unitary matrix Q₁ includes using a Schur decomposition:
Q₁=Q₂*UQ₂⁻¹
where: U is an upper triangular matrix with the principal diagonal being the eigenvalues of Q₁
Q₂ is the second Unitary Matrix.

5. A method as claimed in claim 4 wherein the step of factoring in parallel includes factoring U as follows:
U=MⱼTⱼ
where: Tⱼ is a matrix formed by transposing the elements to the right of the principal diagonal of the j^{th} row of the upper triangular matrix, into the elements below the principal diagonal of the j^{th} column, while leaving all other rows untouched.

6. A method as claimed in claim 5 wherein the transmitter weightings W equals the second unitary matrix.

7. A method as claimed in claim 6 wherein the receiver weightings V equals the inverse of the product of the lower triangular matrix and a complex conjugate of the second unitary matrix to isolate a last signal of the plurality of received signals.

8. A method as claimed in claim 7 wherein the step of factoring in parallel includes factoring U as follows:
U=MⱼTⱼ
where: Tⱼ is a matrix formed by transposing the elements to the right of the principal diagonal of the j^{th} row of the upper triangular matrix, into the elements below the principal diagonal of the j^{th} column, while leaving all other rows untouched.

9. A method as claimed in claim 8 wherein the transmitter weightings W equals the second unitary matrix.

10. A method as claimed in claim 9 wherein the receiver weighting to isolate a jth signal equals an inverse of a product of the lower triangular matrix, a complex conjugate of the second unitary matrix and Mⱼ.

11. A system for communicating multiple input multiple output (MIMO) wireless data comprising:
inputs for a plurality of signals Si;
a network for weighting each of a plurality of signals Si for each of a plurality of transmit antennas and combining signals weighted for each of the plurality of antennas;
a plurality of antennas for transmitting the plurality of combined signals;
a plurality of antennas for receiving a plurality of signals on a plurality of receive antennas;
a receiver for recovering a second plurality of signals So by deriving receiver weightings for each of the plurality of received signals in dependence upon the respective transmitter weightings by factoring a matrix H representative of a channel between the plurality of transmit and receive antennas.

12. A system as claimed in claim 11 wherein the receiver includes:
means for factoring the channel matrix H into two matrices, the second of which is a first unitary matrix;
means for decomposing the first unitary matrix to provide an upper triangular matrix whose principal diagonal comprises eigenvalues of the first unitary matrix and a second unitary matrix; and
means for factoring in parallel rows of the upper triangular matrix to isolate eigenvalues λⱼ ans Soⱼ=λⱼSiⱼ.

13. A system as claimed in claim 12 wherein the means for factoring the channel matrix H includes a LQ decomposition:
H=LQ₁
where: L is a lower triangular matrix
Q₁ is a Unitary matrix.

14. A system as claimed in claim 13 wherein the means for decomposing the first unitary matrix Q₁ includes a Schur decomposition:
Q₁=Q₂*UQ₂⁻¹
where: U is an upper triangular matrix with the principal diagonal being the eigenvalues of Q₁
Q₂ is the second Unitary Matrix.

15. A system as claimed in claim 14 wherein the means for factoring in parallel includes factoring U as follows:
U=MⱼTⱼ
where: Tⱼ is a matrix formed by transposing the elements to the right of the principal diagonal of the j^{th} row of the upper triangular matrix, into the elements below the principal diagonal of the j^{th} column, while leaving all other rows untouched.

16. A system as claimed in claim 15 wherein the transmitter weightings W equals the second unitary matrix.

17. A system as claimed in claim 16 wherein the receiver weightings V equals the inverse of the product of the lower triangular matrix and a complex conjugate of the second unitary matrix to isolate a last signal of the plurality of received signals.

18. A system as claimed in claim 17 wherein the means for factoring in parallel includes factoring U as follows:
U=MⱼTⱼ
where: Tⱼ is a matrix formed by transposing the elements to the right of the principal diagonal of the j^{th} row of the upper triangular matrix, into the elements below the principal diagonal of the j^{th} column, while leaving all other rows untouched.

19. A system as claimed in claim 18 wherein the transmitter weightings W equals the second unitary matrix.

20. A system as claimed in claim 19 wherein the receiver weighting to isolate a jth signal equals an inverse of a product of the lower triangular matrix, a complex conjugate of the second unitary matrix and Mⱼ.
